(19) United States
(12) Patent Application Publication
(10) Pub. No.: US 2009/0058861 A1
(43) Pub. Date: Mar. 5, 2009

(54) Word input support device

(75) Inventors: Seiji Ihara, Kariya-city (JP); Kiyotaka Taguchi, Kariya-city (JP)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city (JP)

(21) Appl. No.: 12/230,572

(22) Filed: Sep. 2, 2008

(30) Foreign Application Priority Data
Sep. 3, 2007 (JP) 2007-227715

(51) Int. Cl. G06T 11/00

(52) U.S. Cl. 345/467

(57) ABSTRACT

A word input support device has a display device and a control circuit. The control circuit classifies an inputted character into multiple character groups, and changes a character group that is displayed according to an intentional operation of a user. If a word desired to be finally inputted is among registered words contained in word dictionary data, characters that can be inputted are narrowed down each time a character is inputted so that changing the display from one character group to another is enhanced. If there is not a character anymore that can be inputted in one character group under display, the word input support device changes its display to another character group, which still has a character that can be inputted.

### CROSS REFERENCE TO RELATED APPLICATION

This application is based on and incorporates herein by reference whole contents of Japanese Patent Application No. 2007-227715 filed on Sep. 3, 2007.

### FIELD OF THE INVENTION

The present invention relates to a word input support device, which sequentially accepts input of a character selected from candidate characters displayed on an image display device.

### BACKGROUND OF THE INVENTION

A conventional word input support device is so constructed that characters as candidates for input are displayed on an image display device and the input of a character selected from the candidate characters displayed on the image display device is sequentially accepted. For example, automobile navigation systems placed in overseas markets outside Japan use the following technique: a technique to classify characters to be inputted into three character groups, “alphabetical characters,” “umlaut characters,” and “numeric characters and symbols” and changing which of these characters should be displayed. This change is made based on an operation carried out by a user to explicitly instruct to change a display screen image. An example of such an operation is attained by pressing a changeover button.

However, according to the above techniques, the following problem arises, if a desired word to be finally selected and inputted is a registered word contained in word dictionary data. The desired word is, for example, is the name of destination, which is input in an automobile navigation system.

As the input of a character is successively or sequentially done, the number of registered words, which contain a string of inputted characters as the result of input at the beginning of the string and is selectable, is reduced. In conjunction with this, characters that can be inputted next are narrowed down. In some cases, there is no character that can be inputted in the presently displayed character group and there remains a character that can be inputted in any other character group. In some cases, there is a character that can be inputted in the presently displayed character group but another character group contains more characters that can be inputted. When a user desires to change the presently displayed character group in these cases, the user must carry out an operation to change the display by himself or herself.

### SUMMARY OF THE INVENTION

It is therefore an object of the present invention to provide a word input support device, which narrows down characters that can be inputted by changing display on an image display device to any one of character groups, which is other than the current character group, if the number of next candidate characters of the current character group becomes less than a predetermined threshold number.

According to one aspect of the present invention, a word input support device has a storage medium for storing word dictionary data containing multiple registered words performs the following operation and changes multiple character groups having multiple characters for input as constituent elements according to an operation by a user and causes an image display device to display the selected character group. When the user utilizes the display on the image display device to specify one character belonging to a character group presently displayed by the image display device of the multiple character groups, this specification of character is accepted. The character group presently displayed by the image display device is referred to a current character group.

A character string obtained by arranging one or more characters acquired by one or more times of the accepting operation in the order of acceptance is referred to as an accepted character string. The word input support device identifies the next candidate characters based on each of one or more accepted character strings. Next candidate character refers to a character next to an accepted character string in a registered word beginning with the accepted character string.

Further, the word input support device changes display, that is, what is displayed on the image display device, based on that the number of characters belonging to the above current character group of one or more identified next candidate characters has become less than a predetermined threshold number. What is displayed on the image display device is changed to any different one of the multiple character groups that is not the current character group and contains one or more next candidate characters.

When the next candidate characters are narrowed down and thus the number of the next candidate characters in the current character group is reduced, there is a high possibility that the user will desire to display any other character group. To incorporate this point of view, the word input support device performs the following operation based on the number of next candidate characters in the current character group has become less than a threshold number: the word input support device changes what is displayed to any other character group containing next candidate characters.

As described above, in addition to an intentional changing operation by the user, reduction in the number of next candidate characters in the current character group is used as a trigger for changing a character group to be displayed. As a result, ease of changing what is displayed from one character group to another can be enhanced.

In this specification, “character” is used as a term including alphabetical characters, hiragana characters, katakana characters, umlaut characters, numeric characters, and symbols.

The above predetermined threshold number may be 1. In this case, the word input support device changes what is displayed to any other character group containing a next candidate character based on that there has not been a next candidate character in the current character group any more.

This operation is based on the following point of view. When next candidate characters are narrowed down and, as a result, the number of next candidate characters in the current character group becomes zero, the following takes place: the chance that the user will desire to change what is displayed to any other character group is near 100 percent. Therefore, the above-described measure makes it possible to grasp the intention of the user with significantly high accuracy and automatically incorporate the intention into screen display change.

The predetermined threshold number may be the largest one of the numbers of next candidate characters contained in the individual character groups other than the current character group. The character group to which the screen display is changed at this time may be the character group containing the largest number of next candidate characters.

This operation is based on the following point of view. When next candidate characters are narrowed down and, as a result, there is present a character group containing more next candidate characters than the current character group does, the following takes place: there is a high possibility that the user will desire to change what is displayed to that character group.

Further, this operation incorporates the following point of view: the character group that most probably contains a character the user inputs next is the character group containing the largest number of next candidate characters. Therefore, the above-described measure makes it possible to grasp the intention of the user with high accuracy and automatically incorporate the intention into the selection of a character group to which the screen display is changed.

With respect to one or more next candidate characters identified by a next candidate character identifying means, the display on the image display device may be varied so that the following is implemented: a next candidate character belonging to the current character group is emphasized as compared with the characters other than the next candidate character in the current character group.

In the conventional apparatuses, the following operation is performed: multiple characters are displayed on an image display device; in the process of successively accepting the input of a character, characters other than a character that can be inputted next are displayed dimmed; and it is thereby indicated that those characters cannot be operated. Consideration will be given to a combination of this technique and a related art of changing what is displayed from one character group to another according to a changing operation by a user.

Even when these related arts are simply combined, characters that can be inputted are narrowed down. However, the result of narrowing-down of characters is incorporated only in the display screen image presently displayed but cannot be applied up to change from one screen display to another that should be dealt with on the same basis as the screen image presently displayed. For example, even when there is not a next candidate character in the character group presently displayed at all, the current character group is not automatically changed.

Adoption of an automatic change function makes it possible to realize a user interface higher in user-friendliness in a retrieval function to narrow down characters that can be inputted next.

The word input support device may change what is displayed on the image display device to a mixed image embracing together next candidate characters belonging to different character groups based on the following: the total number of identified next candidate characters is equal to or less than a threshold number. At this time, the user can utilize the display of this mixed image to specify each of the next candidate characters similarly with characters in the displayed character groups.

When the total number of next candidate characters is small, as described above, the number of operations carried out by the user to change a display screen image by taking the following measure: the next candidate characters are simultaneously displayed on the image display device regardless of difference in character groups to which the next candidate characters belong.

The word input support device may have a list display function to display multiple characters belonging to a character group to be displayed on the image display device in the list form. In this case, the word input support device performs the operation of: changing characters to be selected one by one in the predetermined order of display of the multiple characters in the list form based on a shifting operation by the user; and accepting one character to be selected in a confirming operation by the user as the user-specified character based on the confirming operation.

In this case, the word input support device may perform the operation of: generating an all candidate list composed of all the next candidate characters based on that the total number of identified next candidate characters is equal to or less than the above-described threshold number; continuously arranging the next candidate characters belonging to an identical character group as a unit in the all candidate list; displaying the all candidate list arranged as described above on the image display device in the list form; and taking one next candidate character contained in the character group containing the largest number of next candidate characters as a character to be selected.

When what is to be selected in a next candidate character string displayed in the list form is changed one character by one character to specify a character by an operation by the user, as described above, a problem arises. Even though there is a desired character to be inputted in one screen image, operation by the user is cumbersome when the character is away from the character to be selected in the order of listing.

To cope with this, the following measure is taken when the total number of next candidate characters becomes small in the above case: the next candidate characters are not only displayed on the image display device in a lump but also displayed in the list form with the such an arrangement as of the above-described all candidate list; and one next candidate character in the character group containing the largest number of next candidate characters is taken as what is to be selected. As described above, one character in the character group containing the largest number of next candidate characters (that is, the character group most probably containing a character specified by the user next) is taken as what is to be selected. As a result, the burden on the user carrying out an operation can be reduced.

In the above-described case, the word input support device may perform the operation of: displaying an all candidate list composed of all the next candidate characters on the image display device in the list form (this display is made based on the total number of the next candidate characters identified by the next candidate character identifying operation is equal to or less than the above threshold number); and taking the following next candidate character of all the next candidate characters as a character to be selected: a next candidate character with which the number of registered words beginning with a character string obtained by adding the next candidate character next to an accepted character string is highest.

When the total number of next candidate characters becomes small, as described above, the following measure is taken: the next candidate characters are displayed on the image display device in a lump; and a next candidate character with which the number of registered words that can be inputted after input of the character is highest is automatically taken as what is to be selected. That the number of registered words that can be inputted after input of a character is high means that there is a high possibility that the user will input that character. According to this point of view, this construction makes it possible to reduce the burden on the user carrying out an operation.

In the above-described case, the word input support device may perform the operation of: generating an all candidate list composed of all the next candidate characters based on that the total number of identified next candidate characters is equal to or less than a threshold number; in the all candidate list, arranging all the next candidate characters in the descending order of the number of registered words beginning with a character string obtained by adding the next candidate character next to an accepted character string; and displaying the thus arranged all candidate list on the image display device in the list form.

As described above, next candidate character strings are arranged in the descending order of the number of registered words that can be inputted. That is, next candidate character strings are arranged in the descending order of the possibility of being inputted by the user. As a result, the burden on the user carrying out an operation can be reduced.

### BRIEF DESCRIPTION OF THE DRAWINGS

The above and other objects, features and advantages of the present invention will become more apparent from the following detailed description made with reference to the accompanying drawings. In the drawings:

FIG. 1 is a block diagram of an automobile navigation system, which includes a word input support device of the present invention;

FIG. 2 is a flowchart of a program executed by a control circuit in a first embodiment;

FIG. 3 is a schematic view illustrating an image for alphabetical input, an image for kana input, and an image for numeric and symbol input and switching between these images;

FIG. 4 is a flowchart of a program executed by the control circuit 17 in a second embodiment;

FIG. 5 is a flowchart of a program executed by the control circuit 17 in a third embodiment;

FIG. 6 is a schematic view illustrating an image for mixed input displayed on an image display device in a fourth embodiment;

FIG. 7 is a flowchart of a program executed by the control circuit 17 in a fifth embodiment;

FIG. 8 is a schematic view illustrating an example of a list display screen image in the fifth embodiment;

FIG. 9 is a schematic view illustrating an example of a list display screen image in the fifth embodiment;

FIG. 10 is a flowchart of a program executed by the control circuit 17 in a sixth embodiment;

FIG. 11 is a schematic view illustrating an example of a list display screen image in the sixth embodiment;

FIG. 12 is a flowchart of a program executed by the control circuit 17 in a seventh embodiment; and

FIG. 13 is a schematic view illustrating an example of a list display screen image in the seventh embodiment.

### DETAILED DESCRIPTION OF THE PREFERRED EMBODIMENTS

### First Embodiment

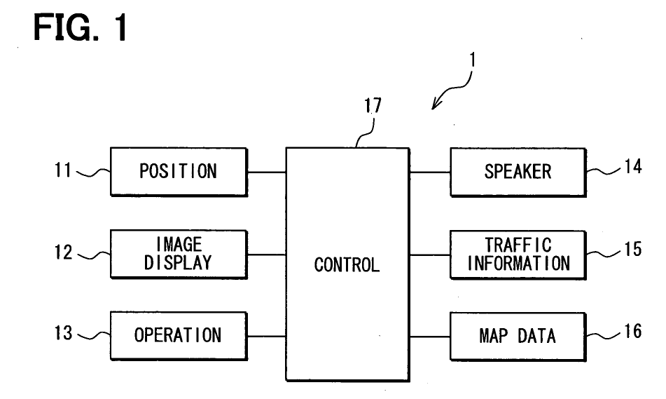

Referring first to FIG. 1, an automobile navigation system 1 includes a position detector 11, an image display device 12, an operation unit 13, a speaker 14, a traffic information receiver 15, a map data acquisition unit 16, and a control circuit (computer) 17.

The position detector 11 includes a geomagnetic sensor, a gyroscope, a vehicle speed sensor, a GPS receiver and the like, which are well known. The position detector 11 outputs to the control circuit 17 information for identifying the present position, orientation and speed of a subject vehicle based on the characteristics of each of these sensors.

The image display device 12 presents an image to a user based on an image signal outputted from the control circuit 17. The displayed images include, for example, a map with the present location in the center, an image for accepting the input of a destination and the like.

The operation unit 13 is constructed of input devices, including multiple mechanical switches provided in the automobile navigation system 1, a touch panel provided over the display surface of the image display device 12 and the like. The operation unit 13 outputs to the control circuit 17 signals based on depression of a mechanical switch and touch on the touch panel by the user.

The traffic information receiver 15 is a wireless receiver (for example, a VICS receiver) that receives information on road congestion, information on traffic control and the like wirelessly transmitted from an FM radio station or roadside equipment installed alongside a road. The traffic information receiver 15 outputs this information to the control circuit 17.

The map data acquisition unit 16 is constructed of a nonvolatile storage medium, such as DVD, CD, and HDD, and a device for reading data from (and, if possible, writing data to) these storage media. The storage medium stores a program executed by the control circuit 17, map data for route guidance and the like.

The map data includes road data and facility data. The road data includes information on the positions and types of links, information on the positions and types of nodes, information on the connections between links and nodes and the like. The facility data includes multiple records with respect to individual facilities, and each record includes data indicating information on the name, address, location, and type of a relevant facility and the like.

The information on the name of a facility refers to a character string (alphabetical characters, symbols, Japanese kana characters) representing the name of the facility. A set of pieces of information on the name of each facility in the facility data functions as dictionary data. The character string representing the name of each facility functions as a registered word. The dictionary data may be stored in the map data acquiring unit 16.

The information on the address of a facility refers to a character string (alphabetical characters, symbols, Japanese kana characters) representing the lot number of a lot where the facility is located. A set of pieces of information on the address of each facility in the facility data functions as dictionary data. The character string representing the lot number of each facility functions as a registered word.

The control circuit 17 includes CPU, RAM, ROM, I/O and the like. The CPU executes a program for the operation of the automobile navigation system 1, read from the ROM or the map data acquisition unit 16. When executing a program, the control circuit 17 performs the operation of: reading information from the RAM, ROM, and map data acquisition unit 16; writing information to the RAM and (if possible) the storage medium of the map data acquisition unit 16; and communicating signals between the control circuit 17 and the position detector 11, image display device 12, operation unit 13, and speaker 14.

The control circuit 17 executes programs of present position identification processing, destination determination processing, guided route computation processing, route guidance processing and the like.

In the present position identification processing, the present position and orientation of the vehicle are identified based on a signal from the position detector 11 using a publicly known technique, such as map matching.

In the destination determination processing, a destination is determined according to an operation to input characters indicating a facility name, a facility lot number, or the like carried out by the user with the operation unit 13. For example, either a mode to determine a destination from a facility name or a mode to input a destination from a facility lot number is selected according to an operation by the user. Then a destination is identified from the dictionary data of facility name information or the dictionary data of address information in accordance with the selected mode.

In the guided route computation processing, an optimum guided route from the present position to a destination determined by the destination determination processing is computed.

In the route guidance processing, the following is implemented: map data is read from the map data acquisition unit 16; an image, obtained by superimposing a computed guided route, a destination, a place of passage, the present position and the like on a map indicated by the map data, is outputted to the image display device 12; and the speaker 14 is caused to output a voice guidance signal instructing right turn, left turn or the like as required, for example, when the subject vehicle is approaching a guided intersection.

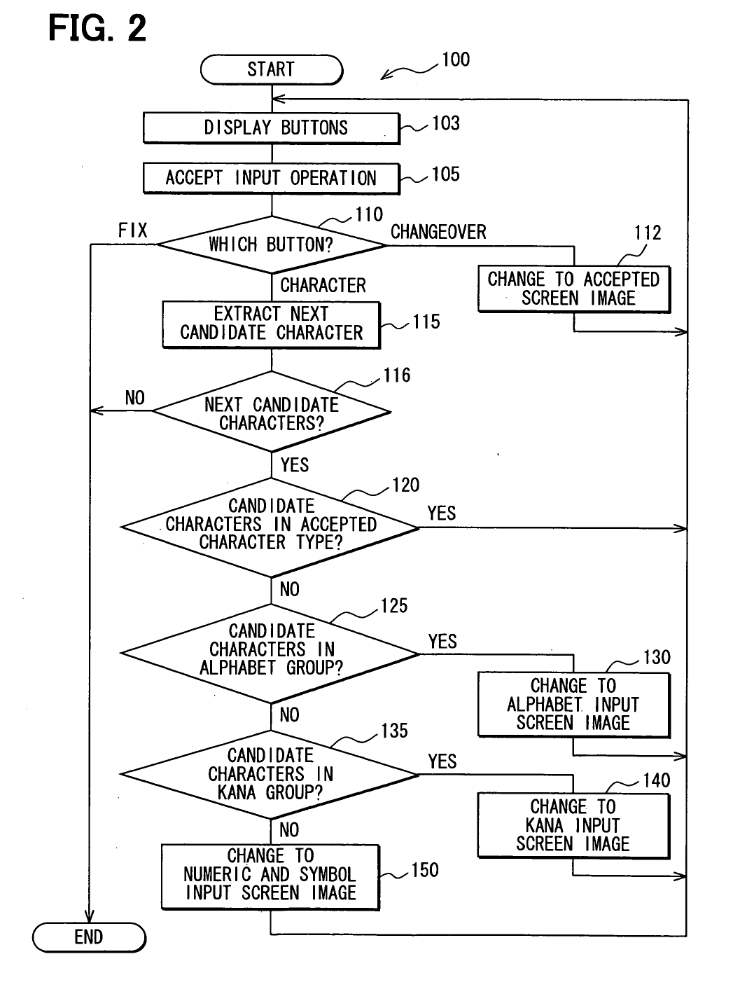

In this embodiment, the control circuit 17 executes a program 100 for narrowing-down processing as illustrated in FIG. 2 to support or assist the input of a destination by the user in each of the above-described modes of the destination determination processing.

In the execution of the program 100, first, the control circuit 17 carries out button display at step 103. The button display is an operation to cause the image display device 12 to display an image for input corresponding to any one of three character groups, (1) alphabetical characters, (2) Japanese kana characters, and (3) numeric characters and symbols.

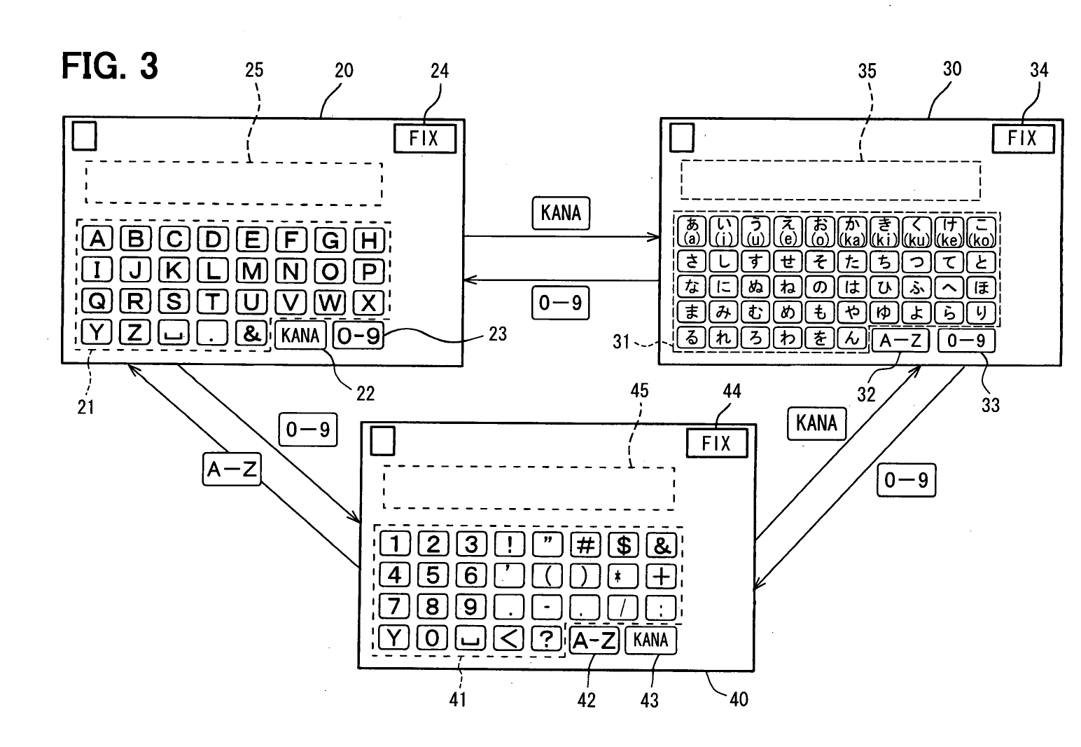

FIG. 3 illustrates examples of an image 20 for alphabetical input, an image 30 for Japanese kana input, and an image 40 for numeric and symbol input.

The image 20 for alphabetical input is used to accept the input of the character group of alphabetical characters by the user. The image 20 for alphabetical input embraces an alphabetical character button group 21, screen image changeover buttons 22, 23, a confirmation (fix) button 24, an accepted character string display area 25 and the like.

The alphabetical character button group 21 is composed of multiple button images that can be specified by the user using the operation unit 13. Each button image represents one character belonging to the character group of alphabetical characters. The alphabetical character button group 21 is for character input by the user.

The screen image changeover buttons 22, 23 are button images that can be specified by the user using the operation unit 13. The screen image changeover button 22 is used to change what is displayed to the image 30 for kana input. The screen image changeover button 23 is used to change what is displayed to the image 40 for numeric and symbol input.

The fix button 24 is a button image that can be specified by the user using the operation unit 13 for the confirming operation described later. The accepted character string display area 25 is used to display the accepted character string described later.

The image 30 for kana input is used to accept the input of the character group of “Japanese kana characters (Japanese alphabetical characters)” by the user. The image 30 for kana input embraces a Japanese kana character button group 31, screen image changeover buttons 32, 33, a fix button 34, and an accepted character string display area 35 and the like.

The Japanese kana character button group 31 is composed of multiple button images that can be specified by the user using the operation unit 13. Each button image represents one character belonging to the character group of “Japanese kana characters.” The Japanese kana character button group 31 is for character input by the user. As an example, only ten kana character buttons in the first line of the button group 31 of the image 30 is indicated with respective corresponding alphabetical letters in brackets like (a), (i), (u), (e), (o), (ka), (ki), (ku), (ke) and (ko) for brevity. These alphabetical letters are usually used to translate a Japanese letter into a non-Japanese language (e.g., English). Other Japanese kana character buttons of the second to the fifth lines in the button group 31 may be indicated in the similar manner.

The screen image changeover buttons 32, 33 are button images that can be specified by the user using the operation unit 13. The screen image changeover button 32 is used to change what is displayed to the image 20 for alphabetical input. The screen image changeover button 33 is used to change what is displayed to the image 40 for numeric and symbol input. The fix button 34 and the accepted character string display area 35 respectively have the same functions as the fix button 24 and the accepted character string display area 25.

The image 40 for numeric and symbol input is used to accept the input of the character group of numeric characters and symbols by the user. The image 40 for numeric and symbol input embraces a numeric character/symbol button group 41, screen image changeover buttons 42, 43, a fix button 44, an accepted character string display area 45 and the like.

The numeric character/symbol button group 41 is composed of multiple button images that can be specified by the user using the operation unit 13. Each button image represents one character belonging to the character group of numeric characters and symbols. The numeric character/symbol button group 41 is for character input by the user.

The screen image changeover buttons 42, 43 are button images that can be specified by the user using the operation unit 13. The screen image changeover button 42 is used to change what is displayed to the image 20 for alphabetical input. The screen image changeover button 43 is used to change what is displayed to the image 30 for kana input. The fix button 44 and the accepted character string display area 45 respectively have the same functions as the fix button 24 and the accepted character string display area 25.

In the following description, the image for input, the image 20 for alphabetical input, image 30 for kana input, or image 40 for numeric and symbol input, presently displayed by the image display device 12 will be referred to as current image. A button image belonging to any of the alphabetical character button group 21, Japanese kana character button group 31, and numeric character/symbol button group 41 will be referred to as character button.

At step 105, subsequently, the control circuit 17 waits for an operation with the operation unit 13 by the user. When there is an operation by the user to specify one button in the current image, the control circuit 17 accepts this operation.

At step 110, subsequently, the control circuit 17 checks which the accepted button is, a character button, a screen image changeover button, or the fix button. When the accepted button is a character button, the control circuit 17 subsequently carries out the processing of step 115. When the accepted button is a screen image changeover button, the control circuit 17 subsequently carries out the processing of step 112. When the accepted button is the fix button, the control circuit 17 subsequently terminates the execution of the program 100.

At step 112, to which the processing proceeds to the screen image changeover button is accepted, the control circuit 17 changes the current image to the image for input corresponding to the accepted screen image changeover button. Following step 112, the current image to which the display image was changed is displayed on the image display device 12 at step 103.

After a character button is accepted, the current image is changed or maintained according to the character represented by the accepted character button, as described below, and the processing of step 103 is thereafter carried out again. Therefore, when the user does not specify the fix button and successively specifies a character button or a screen image changeover button, the following takes place: the control circuit 17 appropriately changes the current image and successively accepts the input of a character by the user using the current image.

At step 115, the control circuit 17 identifies a character string, obtained by arranging the characters accepted after the start of the execution of the program 100 in the order of acceptance, as accepted characters. As an example, it will be assumed that a hiragana character of “KI” a hiragana character of “FU,” and an alphabetical character of “I” are successively inputted in the mode for inputting a facility name. Here, the hiragana character “KI” may be input by pressing the button, which is in the first line, the seventh button from left, and indicated as (ki). In this case, a character string of “KIFU I” is taken as accepted characters.

At step 115, further, the control circuit 17 searches the dictionary data in the facility data and extracts a registered word beginning with the accepted character string. When “KIFU I” is the accepted character string, the registered words, “KIFU IC,” “KIFU IC CHI P PU SE N TA -,” “KIFU I 216 BA N KU,” and the like are extracted.

At step 115, further, the control circuit 17 extracts characters next to the accepted character string as next candidate characters with respect to each of the extracted character strings. In the above example, the next candidate characters are “C,” “2,” and the like. These next candidate characters are characters that can be inputted next.

At step 116, subsequently, the control circuit 17 checks whether one or more characters have been extracted as the next candidate character. When one or more characters have been extracted as the next candidate character, the control circuit 17 carries out the processing of step 120. When one or more characters have not been extracted as the next candidate character, the control circuit 17 terminates the execution of the program 100.

At step 120, the control circuit 17 checks whether the character group corresponding to the current image (that is, the type of the character accepted immediately before) contains one or more different next candidate characters. When the control circuit 17 determines that one or more different next candidate characters are contained, the control circuit 17 subsequently carries out the processing of step 103. As a result, the current image is kept displayed. When the control circuit 17 determines that one or more different next candidate characters are not contained, the control circuit 17 subsequently carries out the processing of Step 125.

At step 125, the control circuit 17 checks whether the character group of alphabetical characters contains one or more different next candidate characters. When the control circuit 17 determines that one or more different next candidate characters are contained, the control circuit 17 subsequently carries out the processing of step 130. When the control circuit 17 determines that one or more different next candidate characters are not contained, the control circuit 17 subsequently carries out the processing of step 135. At step 130, the control circuit 17 changes the current image to the image 20 for alphabetical input and then carries out the processing of step 103.

At step 135, the control circuit 17 checks whether the character group of “Japanese kana characters” contains one or more different next candidate characters. When the control circuit 17 determines that one or more different next candidate characters are contained, the control circuit 17 subsequently carries out the processing of step 140. When the control circuit 17 determines that one or more different next candidate characters are not contained, the control circuit 17 subsequently carries out the processing of step 150. At step 140, the control circuit 17 changes the current image to the image 30 for kana input and then carries out the processing of step 103.

At step 150, the control circuit 17 changes the current image to the image 40 for numeric and symbol input and then carries out the processing of step 103. Thus, the display image is changed at step 150 for the reason that, when the extracted next candidate character is not an alphabetical character or a “Japanese kana character,” the next candidate character is a numeric character or a symbol without doubt.

At step 103, the control circuit 17 may vary the display on the image display device 12 so that the character button corresponding to the next candidate character in the current image is emphasized as compared with the character buttons for others than the next candidate character. Specifically, the character buttons for others than the next candidate character may be displayed in a darkened color. In this case, the control circuit 17 may reject the input of any character button for other than the next candidate character at step 105.

By executing the above-described program 100, the control circuit 17 changes what is displayed on the image display device 12 according to a changing operation by the user, by steps 105, 110 and 112. The control circuit 17 changes what is displayed to any of the image 20 for alphabetical input, image 30 for kana input, and image 40 for numeric and symbol input at step 112. When the user utilizes the image for input as what is displayed (equivalent to the image representing the current character group) to specify one character, the control circuit 17 accepts the specified character by steps 105, 110 and 115.

Further, the control circuit 17 performs the operation of: identifying an accepted character string obtained by arranging one or more characters successively or sequentially specified by the user as described above in the order of acceptance; searching for a character string beginning with the accepted character string among the multiple character strings representing facilities in the facility data; and identifying a character next to the accepted character string in the relevant character string as a next candidate character at step 115.

When there are one or more different next candidate characters at step 116, the control circuit 17 selects an image to be displayed at steps 120 to 150.) More specifically, when the present display image to be displayed contains one or more next candidate characters at step 120, the control circuit 17 maintains the present display image to be displayed. When the present display image to be displayed does not contain a next candidate character at all at step 120, the control circuit 17 searches for a character group containing a next candidate character at steps 125 and 135. At this time, the control circuit 17 searches in a predetermined order with respect to the character groups, for example, in the order of alphabetical characters to hiragana characters to numeric characters and symbols. Then the control circuit 17 changes what is displayed to the image for input of the character group that applies first at steps 130, 140 and 150.

When there is not a next candidate character anymore at step 116, or when the user performs an operation to terminate the input of a character at step 110, the control circuit 17 terminates the narrowing-down processing. In the destination determination processing, the control circuit 17 identifies the accepted character string at this point of time as the name of a destination or the lot number of a destination.

As-described above, the automobile navigation system 1 changes what is displayed on the image display device based on the following fact: the number of characters belonging to the current character group of the one or more-identified next candidate characters becomes less than a predetermined threshold number. The control circuit 17 changes what is displayed to the following one of the multiple character groups: any one character group that is not the current character group and contains one or more of one or more next candidate characters.

When next candidate characters are narrowed down and, as a result, the number of next candidate characters in the current character group is reduced, the following takes place: there is a high possibility that the user will desire to change what is displayed to any other character group. To incorporate this point of view, the word input support device performs the following operation based on that the number of next candidate characters in the current character group has become less than the threshold number: the control circuit 17 changes what is displayed to any other character group containing next candidate characters.

In addition to an intentional changing operation by a user, as described above, reduction in the number of next candidate characters in the current character group is used as a trigger for changing the character group to be displayed. As a result, ease of changing the display from one character group to another can be enhanced.

In the first embodiment, one (1) is used as the predetermined threshold number. In this case, the automobile navigation system 1 changes what is displayed to any other character group containing a next candidate character based on that there is not a next candidate character in the current character group anymore.

This operation incorporates the following point of view: when next candidate characters are narrowed down and, as a result, the number of next candidate characters in the current character group becomes zero, the following takes place: the chance that the user will desire to change what is displayed to any other character group is near 100 percent. Therefore, the above-described measure makes it possible to grasp the intention of the user with significantly high accuracy and automatically incorporate the intention into screen display change.

In the conventional apparatus, the following operation is performed: multiple characters are displayed on an image display device; in the process of successively accepting the input of a character, characters other than a character that can be inputted next are displayed dimmed; and it is thereby indicated that those characters cannot be operated. Even when this technique and related arts for changing the display among multiple character groups according to a changing operation by a user are simply combined, characters that can be inputted are narrowed down. However, the result of narrowing-down of characters is incorporated only in the display screen image presently displayed. The result of narrowing-down cannot be applied up to change from one screen display to another that should be dealt with on the same basis as the display screen image presently displayed. For example, even when there is not a next candidate character in the image for input presently displayed at all, the image for input is not automatically changed.

Adoption of such an automatic change function as in the first embodiment makes it possible to realize a user interface higher in user-friendliness in a retrieval function to narrow down characters that can be inputted next.

In the first embodiment, the control circuit 17 functions as an example of a first display changing controlling means by carrying out the processing of step 112 of the program 100; as an example of a specification accepting means by carrying out the processing of step 105 and dealing with the branch from step 110 to step 115; as an example of a next candidate character identifying means by carrying out the processing of step 115; as an example of a second display changing controlling means by carrying out the processing of steps 116 to 150; and as an example of a display change controlling means by carrying out the processing of step 103.

### Second Embodiment

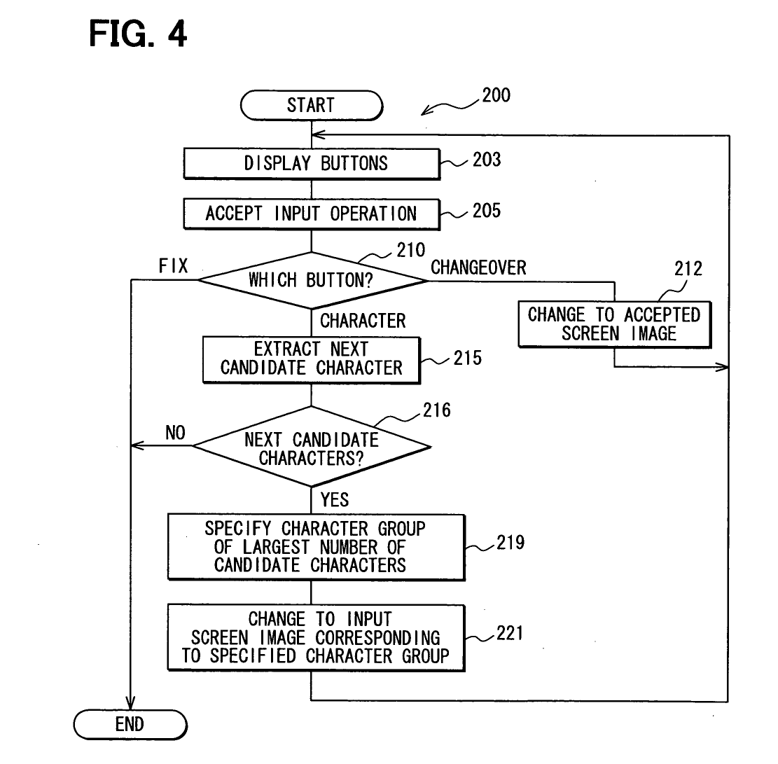

A second embodiment is different from the first embodiment in that the control circuit 17 executes a program 200 illustrated in FIG. 4 in place of the program 100.

The details of the processing of steps 203, 205, 210, 212, 215 and 216 of the program 200 are respectively the same as the processing of steps 103, 105, 110, 112, 115 and 116 of the program 100. Therefore, the description of the processing of these steps will be omitted.

When the control circuit 17 determines that there are one or more next candidate characters at step 216, the control circuit 17 subsequently identifies a character group containing the largest number of next candidate characters at step 219. At this time, next candidate characters are counted on a different character-by-different character basis. As an example, it will be assumed that an accepted character string is “KIFU I” and there are only four registered words having the accepted character string at the beginning thereof, “KIFU IC,” “KIFU IC CHI P PU SE N TA -,”“KIFU I 216BA N KU” and “KIFU I 302 BA N KU.” In this case, the number of next candidate characters contained in the alphabetical character group is one, or “C,” and the number of next candidate characters contained in the numeric character and symbol group are two, or “2” and “3.”

At step 221, subsequently, the control circuit 17 changes the current image to the image for input corresponding to the character group identified at step 219 and then carries out the processing of step 203.

By executing the above-described program 200, the control circuit 17 changes the current image to the image for input corresponding to a character group containing the largest number of next candidate characters at steps 219 and 221.

As described above, the automobile navigation system 1 changes the current image when the number of next candidate characters embraced in the current image becomes smaller than the following number: the largest one of the numbers of next candidate characters contained in other individual character groups. The image for input to which the current image is changed at this time is the image for input of a character group containing the largest number of next candidate characters.

This operation incorporates the following point of view: when next candidate characters are narrowed down and, as a result, there is present a character group containing more next candidate characters than the current character group does, there is a high possibility that the user will desire to change what is displayed to that character group.

Further, the above operation incorporates the following point of view: a character group that most probably contains a character inputted by a user next is a character group containing the largest number of next candidate characters. Therefore, the above-described measure makes it possible to grasp the intention of the user with significantly high accuracy and automatically incorporate the intention into the selection of a character group to which the screen display is changed.

In the second embodiment, the control circuit 17 functions as an example of a first display changing controlling means by carrying out the processing of step 212 of the program 200; as an example of a specification accepting means by carrying out the processing of step 205 and dealing with the branch from step 210 to step 215; as an example of a next candidate character identifying means by carrying out the processing of step 215; as an example of a second display changing controlling means by carrying out the processing of steps 216 to 221; and as an example of a display change controlling means by carrying out the processing of step 203.

### Third Embodiment

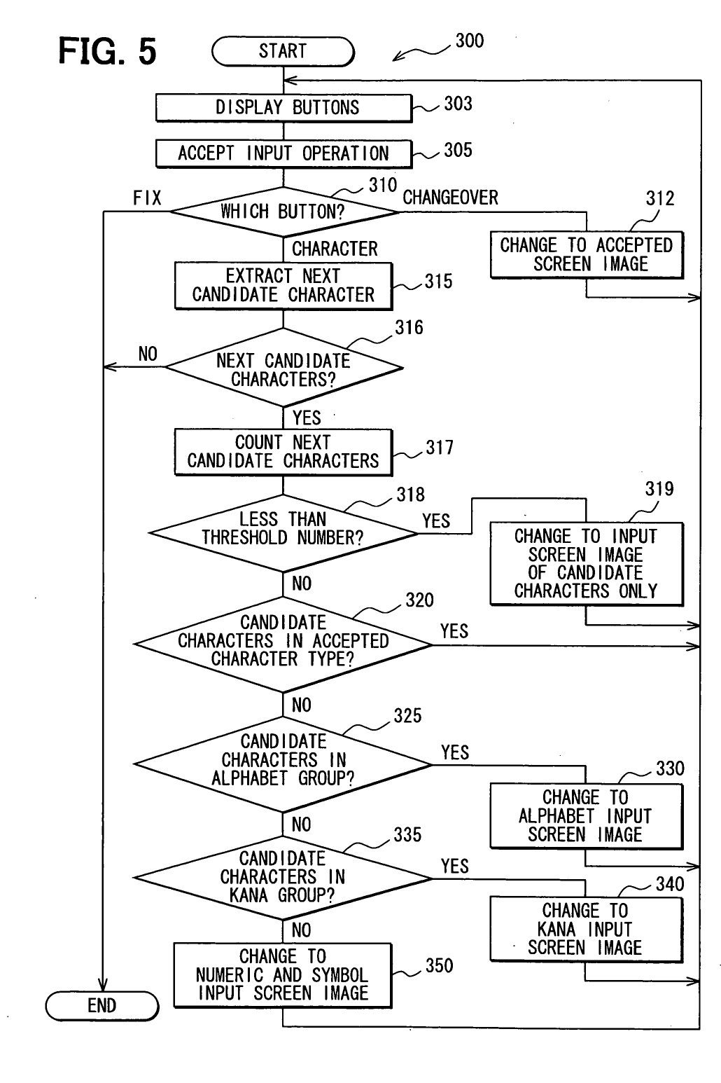

A third embodiment is different from the first embodiment in that the control circuit 17 executes a program 300 illustrated in FIG. 5 in place of the program 100.

The details of the processing of steps 303, 305, 310, 312, 315, 316, 320, 325, 330, 335, 340 and 350 of the program 300 are respectively the same as the processing of steps 103, 105, 110, 112, 115, 116, 120, 125, 130, 135, 140 and 150 of the program 100. Therefore, the description of the processing of these steps will be omitted.

When the control circuit 17 determines that the number of next candidate characters is one or more at step 316, the control circuit 17 subsequently identifies or counts the number of next candidate characters at step 317. At step 318, subsequently, the control circuit 17 checks whether the identified number of next candidate characters is equal to or less than a predetermined threshold number. In this embodiment, this threshold number is the maximum value of the number of character buttons that can be displayed in one screen page. When the identified number of next candidate characters is equal to or less than the threshold number, the control circuit 17 subsequently carries out the processing of step 319. When the identified number of next candidate characters is more than the threshold number, the control circuit 17 subsequently carries out the processing of step 320.

At step 319, the control circuit 17 simultaneously displays next candidate characters belonging to different character groups in one screen page. More specifically, an image for input embracing character button images respectively corresponding to all the next candidate characters is displayed on the image display device 12. The character button images embraced in the display image on the image display device 12 at this time are all character button images corresponding to next candidate characters. Following step 319, the control circuit 17 carries out the processing of step 303.

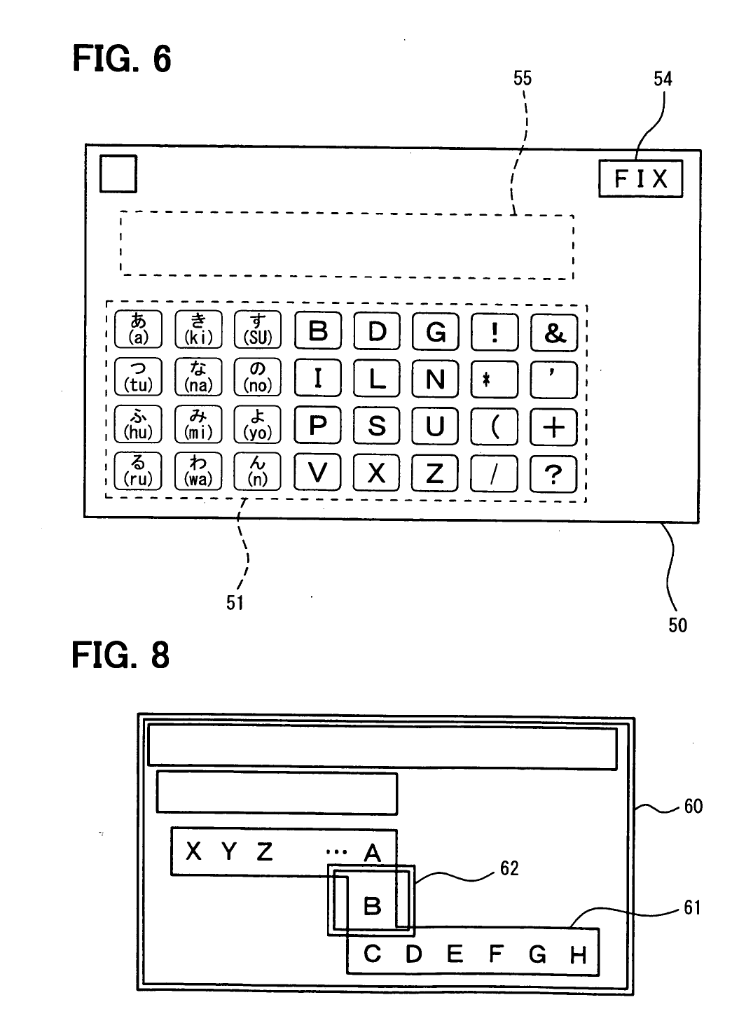

FIG. 6 illustrates an example of an image 50 for mixed input displayed on the image display device 12 when the processing of step 303 is carried out following step 319. The image 50 for mixed input embraces character button images 51 of multiple next candidate characters belonging to different character groups in addition to a fix button 54 and an accepted character display area 55.

As described above, the control circuit 17 changes what is displayed on the image display device 12 to an image containing all the next candidate characters at step 319 based on the following: the identified total number of next candidate characters is equal to or less than the threshold number at step 318. Since the processing of step 303 and the following steps is carried out after step 319, the user can utilize the above display for input to specify each next candidate character similarly with characters in a displayed character group.

When the total number of next candidate characters is small, as described above, the next candidate characters are simultaneously displayed on the image display device 12 in a lump. As a result, the user can input the next character without necessity for any operation to change the display screen image.

In the third embodiment, the control circuit 17 functions as an example of a first display changing controlling means by carrying out the processing of step 312 of the program 300; as an example of a specification accepting means by carrying out the processing of step 305 and dealing with the branch from step 310 to step 315; as an example of a next candidate character identifying means by carrying out the processing of step 315; as an example of a second display changing controlling means by carrying out the processing of steps 316 to 350; and as an example of a display change controlling means by carrying out the processing of step 303.

### Fourth Embodiment

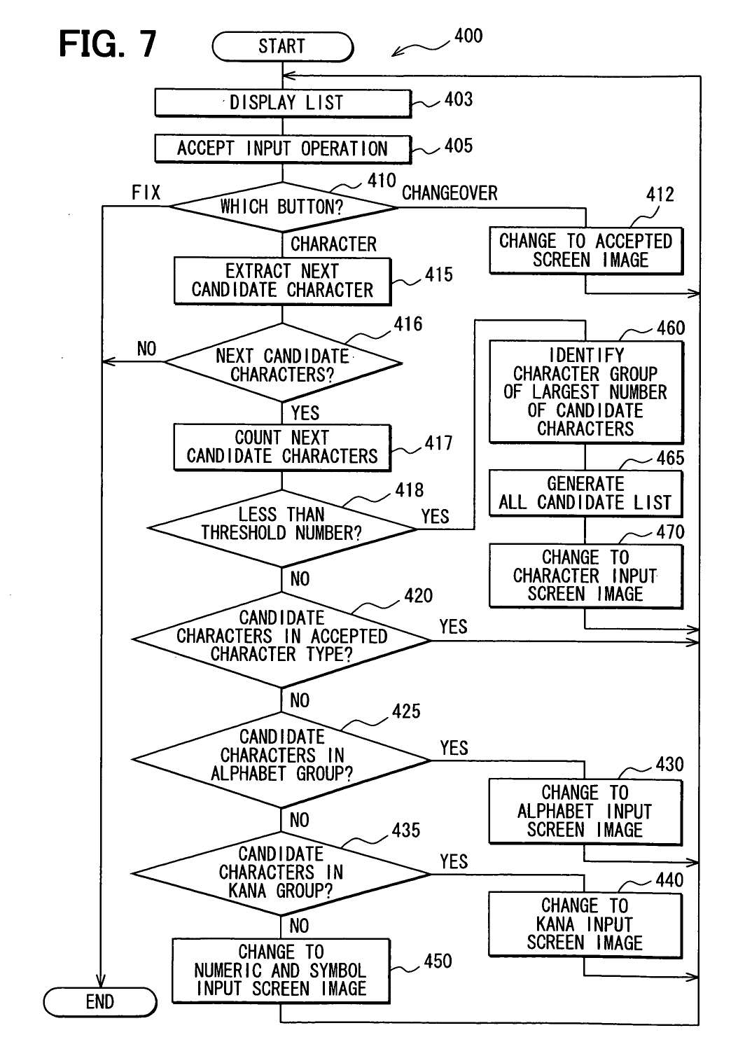

A fourth embodiment is different from the third embodiment in that the control circuit 17 executes a program 400 illustrated in FIG. 7 in place of the program 300.

The details of the processing of steps 403, 405, 410, 412, 415, 416, 417, 418, 420, 425, 430, 435, 440 and 450 of the program 400 are respectively the same as the processing of steps 303, 305, 310, 312, 315, 316, 317, 318, 320, 325, 330, 335, 340 and 350 of the program 300. Unlike the third embodiment, however, the image for input is displayed in a list form.

FIG. 8 illustrates an example of an image for input in the list form. In the list form, the character button images corresponding to individual characters belonging to a character group to be displayed are arranged in a line in a predetermined displaying sequence (for example, in the sequence used in dictionaries). In the example in FIG. 8, the display in a list portion 61 is equivalent to this in-line display. In the list form, one of the character button images is an object to be selected. In the example in FIG. 8, the character button image of “B” displayed in a focused portion 62 in an emphasized manner is an object to be selected.

At step 405, the control circuit 17 can change the character to be selected one by one in the above-described displaying sequence according to a shifting operation by the user using the operation unit 13. At step 405, further, the control circuit 17 accepts one character as an object to be selected in a fixing operation by the user using the operation unit 13 as a user-specified character based on the confirming operation.

When a character, which is to be selected in a next candidate character displayed in the list form, is changed one character by one character to specify a character by an operation by the user, as described above, a problem may arises. Even though there is a desired character to be inputted in one screen image, the number of times of operation by the user is increased when the character is away from the character to be selected in the order of listing. Therefore, the operation by the user is made cumbersome.

Consequently, when the control circuit 17 determines that the number of next candidate characters is equal to or less than the threshold number at step 418, the control circuit 17 subsequently performs the following operation at step 460: the control circuit 17 identifies a group among the character groups that contains the largest number of candidate characters that can be inputted next. In this embodiment, the above threshold number is equivalent to the maximum number of character button images that can be displayed in one screen page.

At step 465, the control circuit 17 generates an all candidate list. The all candidate list includes all the next candidate characters and includes only the next candidate characters. Therefore, the all candidate list often includes next candidate characters belonging to different character groups. In the all candidate list, the next candidate characters are so arranged that the next candidate characters belonging to an identical character group are continuously aligned in a lump. In an identical character group, the next candidate characters are arranged in a sequence predetermined with respect to that character group (for example, in the sequence used in dictionaries).

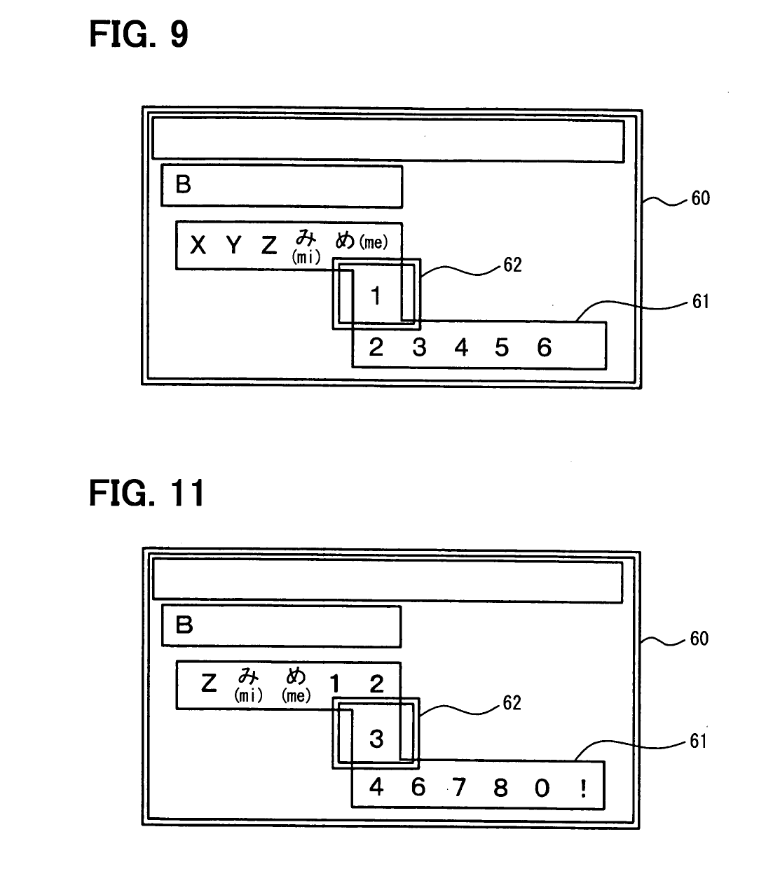

At step 465, further, the control circuit 17 identifies a character at the top of a character list containing the largest number of next candidate characters in such an image as a character to be selected. For example, when the numeric character and symbol group contains the largest number of next candidate characters, the following operation is performed: “1” as the character at the beginning of that character group is taken as an object to be selected as illustrated in the list display screen image 60 in FIG. 9.

Following step 465, the control circuit 17 changes the current image to an image for input composed of that all candidate list at step 470. At step 403, further, the control circuit 17 causes the image display device 12 to display the image for input.

As described above, the control circuit 17 performs the following operation when the total number of next candidate characters becomes small: the control circuit 17 displays the next candidate characters on the image display device in a lump; and further the control circuit 17 makes list display in such an arrangement as in the above-described all candidate list and takes the next candidate character at the beginning of a character group containing the largest number of next candidate characters as an object to be selected. As described above, the first character in a character group containing the largest number of next candidate characters is taken as an object to be selected. The above character group is a character group that most probably contains a character specified by the user next. As a result, the burden on the user carrying out an operation can be reduced.

In the fourth embodiment, the control circuit 17 functions as an example of a first display changing controlling means by carrying out the processing of step 412 of the program 400; as an example of a specification accepting means by carrying out the processing of step 405 and dealing with the branch from step 410 to step 415; as an example of a next candidate character identifying means by carrying out the processing of step 415; as an example of a second display changing controlling means by carrying out the processing of steps 416 to 470; and as an example of a list display controlling means by carrying out the processing of step 403.

### Fifth Embodiment

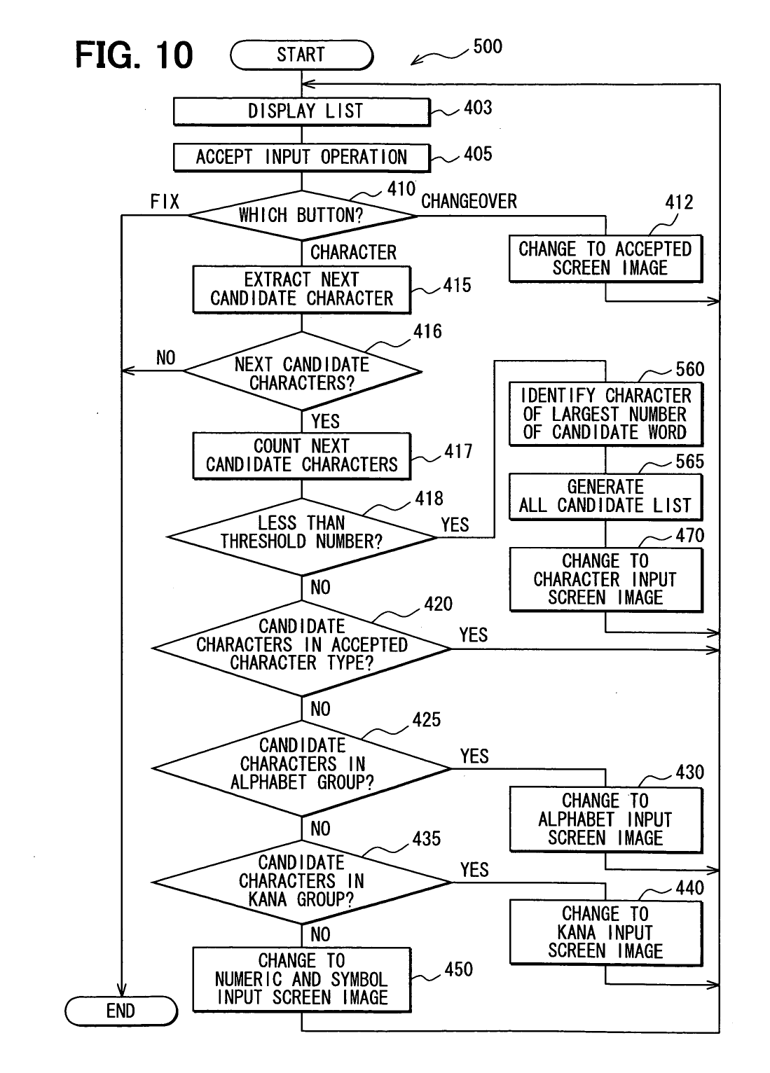

A fifth embodiment is different from the fourth embodiment in that the control circuit 17 executes a program 500 illustrated in FIG. 10 in place of the program 400. The program 500 is different from the program 400 in that the processing of steps 460 and 465 is respectively replaced with the processing of steps 560 and 565.

At step 560, to which the processing proceeds to after it is determined that the number of next candidate characters is equal to or less than the threshold number, the control circuit 17 carries out the following processing: the control circuit 17 identifies a character, which can be inputted next and has the largest number of candidate words among next candidate characters. This character having the largest number of candidate words refers to the following next candidate character: a next candidate character with which the number of registered words beginning with a character string obtained by adding the next candidate character next to the accepted character string is maximized among the registered words in dictionary data.

As an example, it will be assumed that the accepted character string is “KIFU I” and there are only three registered words having the accepted character at the beginning thereof, “KIFU ICU,” “KIFU IC CHI P PU SE N TA -” and “KIFU I 216 BA N KU.” In this case, of the next candidate characters of “C” and “2,” the next candidate character of “C” is a character having the largest number (two) of candidate words that can be inputted next.

At step 565, subsequently, the control circuit 17 generates an all candidate list in the same arrangement as in the fourth embodiment. In this embodiment, however, a character to be selected in the all candidate list is the next candidate character having the largest number of candidate words that can be inputted next, identified at step 560 as shown in FIG. 11.

When the total number of next candidate characters becomes small, as described above, the next candidate characters are displayed on the image display device 12 in a lump. Furthermore, a next candidate character having the largest number of registered words that can be inputted after that character is inputted is automatically taken as an object to be selected. When there are many registered words that can be inputted after some character is inputted, there is a high possibility that the user will input that character. According to this point of view, the burden on the user carrying out an operation can be reduced by taking the above measure.

In the fifth embodiment, the control circuit 17 functions as an example of a first display changing controlling means by carrying out the processing of step 412 of the program 500; as an example of a specification accepting means by carrying out the processing of step 405 and dealing with the branch from step 410 to step 415; as an example of a next candidate character identifying means by carrying out the processing of step 415; as an example of a second display changing controlling means by carrying out the processing of steps 416 to 450, 560, 565 and 470; and as an example of a list display controlling means by carrying out the processing of step 403.

### Sixth Embodiment

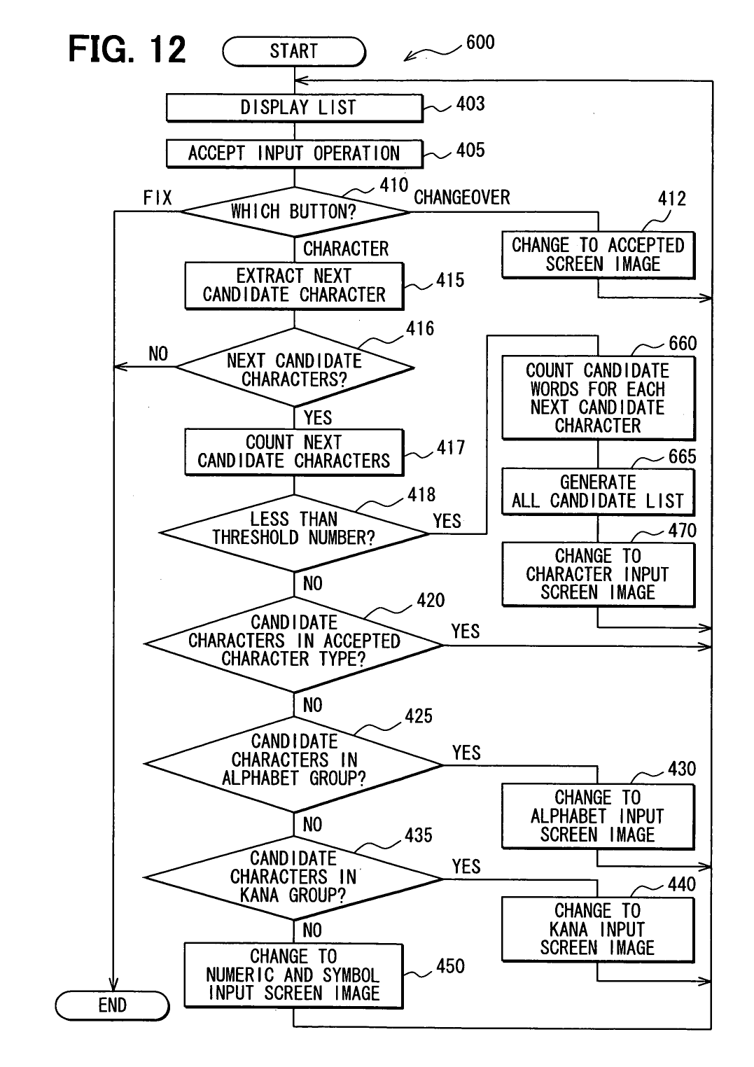

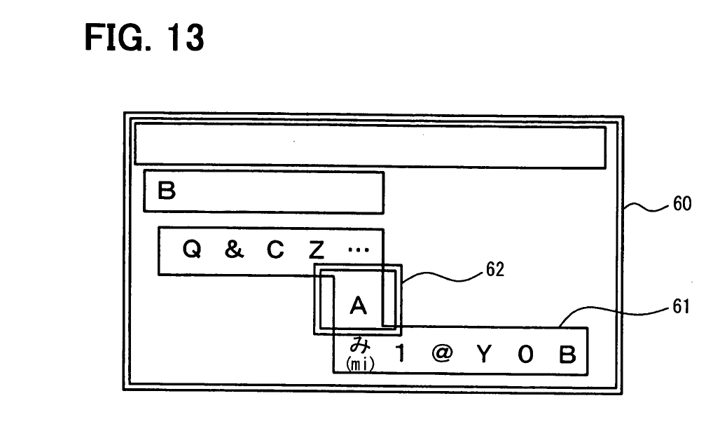

A sixth embodiment is different from the fourth embodiment in that the control circuit 17 executes a program 600 illustrated in FIG. 12 in place of the program 400. The program 600 is different from the program 400 in that the processing of steps 460 and 465 is respectively replaced with the processing of steps 660 and 665. At step 660, to which the processing proceeds after it is determined that the number of next candidate characters is equal to or less than the threshold number, the control circuit 17 carries out the following processing: the control circuit 17 counts the number of candidate words that can be inputted next (hereafter, referred to as the number of enterable words) with respect to each next candidate character.

At step 665, subsequently, the control circuit 17 generates an all candidate list. In this embodiment, the all candidate list includes next candidate characters belonging to different character groups, includes all the next candidate characters, and includes only the next candidate character. In this regard, the all candidate list in this embodiment is the same as the all candidate list in the fourth embodiment. In the all candidate list, however, the next candidate characters are arranged in the descending order of the number of enterable words identified at step 660 regardless of the character group to which each next candidate character belongs. In such a display image, at step 465, the next candidate character largest in number of enterable words is identified as a character to be selected.

As described above, a next candidate character is arranged in the descending order of number of registered words that can be inputted, that is, in the descending order of the possibility of being inputted by the user. As a result, the burden on the user carrying out an operation can be reduced.

In the sixth embodiment, the control circuit 17 functions as an example of a first display changing controlling means by carrying out the processing of step 412 of the program 600; as an example of a specification accepting means by carrying out the processing of step 405 and dealing with the branch from step 410 to step 415; as an example of a next candidate character identifying means by carrying out the processing of step 415; as an example of a second display changing controlling means by carrying out the processing of steps 416 to 450, 660, 665 and 470; and as an example of a list display controlling means by carrying out the processing of step 403.

### Other Embodiments

The present invention is not limited to the above embodiments and includes various embodiments other than the above embodiments.

In the above embodiments, the automobile navigation system implements as an example of a word input support device. However, the invention is applicable not only to the automobile navigation system 1 but also to any word input support device as long as the device has dictionary data and accepts the input of a registered word in the dictionary data.

In the above embodiments, the map data acquisition unit 16 is a storage medium. The storage medium for storing dictionary data may be of any type.

At step 103, 203 or 303 in the first to third embodiments, it is not always required to emphasize a next candidate character as compared with other characters. Even though all the buttons corresponding to the characters belonging to an identical character group are evenly displayed, the advantage of the invention is achieved.

In the description of the above embodiments, cases where the display image is changed between three character groups, alphabetical characters, Japanese kana characters, and numeric characters and symbols, are taken as examples. The character groups between which the display image is changed need not be these character groups and, for example, the following three character groups may be used: alphabetical characters, umlaut characters, and numeric characters and symbols.

At step 465 in the fourth embodiment, the character to be selected in the all candidate list need not be the first character in a character group containing the largest number of next candidate characters. The user-friendliness is enhanced as long as the character to be selected is any character belonging to a character group containing the largest number of next candidate characters.

In the third to sixth embodiments, the maximum number of next candidate characters that can be displayed in one screen page is taken as the threshold number. The threshold number may be larger than the maximum number of next candidate characters that can be displayed in one screen page. In this case, the control circuit 17 cannot display all the next candidate characters in one screen page.

To cope with this, the control circuit 17 in the third embodiment only has to be so constructed as to perform the following operation: the control circuit 17 generates multiple display screen images for input that cover all the next candidate characters as a whole and changes what is displayed between these display screen images for input according to a selecting operation by the user. The control circuit 17 in the fourth to sixth embodiments only has to be so constructed as to cause the image display device 12 to display only part of the all candidate list in proximity to an object to be selected. Even with these constructions, it is possible to display such a display screen image for input that the following is implemented: character button images corresponding to characters belonging to different character groups are simultaneously embraced; and at the same time, character button images for others than a next candidate character are not embraced. Therefore, necessity for the user to change the display screen image is reduced.

The functions implemented by the control circuit 17 executing a program in each of the above embodiments may be implemented using hardware having the same functions. An example of the above hardware is FPGA whose circuitry is programmable.

What is claimed is:

1. A word input support device comprising:
an image display device;
a storage medium for storing word dictionary data including a plurality of registered words; and
a control circuit connected to the image display device and the storage medium,
wherein the control circuit includes:
a first display changing controlling means for changing a plurality of character groups each containing a plurality of characters as constituent elements and displaying each character group on the image display device according to an operation by a user;
a specification accepting means for accepting a character, which is specified by the user by utilizing display on the image display device as one character belonging to a current character group being currently displayed on the image display device;
a next candidate character identifying means for identifying, in each of the registered words beginning with the accepted character string, next candidate characters, which come next to the accepted character string obtained by arranging one or more characters accepted by the specification accepting means in the order of acceptance; and
a second display changing controlling means for changing the display on the image display device to any one of character groups, which is other than the current character group and contains one or more next candidate characters of the character groups, if the number of next candidate characters of the current character group identified by the next candidate character identifying means becomes less than a predetermined threshold number.

2. The word input support device of claim 1, wherein:
the predetermined threshold number is one.

3. The word input support device of claim 1, wherein:
the predetermined threshold number is the largest number of the numbers of next candidate characters contained in each of the character groups other than the current character group of the character groups; and
the second display changing controlling means changes the display on the image display device to a character group having the largest number of next candidate characters of the character groups based on that the number of characters belonging to the current character group of the one or more next candidate characters identified by the next candidate character identifying means becomes less than the predetermined threshold number.

4. The word input support device of claim 1, wherein:
the control circuit further includes a display change controlling means for changing the display on the image display device so that a next candidate character belonging to the current character group of the one or more next candidate characters identified by the next candidate character identifying means is emphasized as compared with characters other than the next candidate character in the current character group.

5. The word input support device of claim 1, wherein:
the second display changing controlling means changes the display on the image display device to a mixed image embracing next candidate characters belonging to different character groups together based on that the total number of the next candidate characters identified by the next candidate character identifying means is equal to or less than a threshold number; and
when the mixed image is being displayed and one character of the next candidate characters being displayed is specified by the user utilizing the display on the image display device, the specification accepting means accepts the specified one character.

6. The word input support device of claim 5, wherein:
the control circuit further includes a list display controlling means for causing the image display device to display, in a list form, a plurality of characters belonging to a character group determined to be displayed by the first display changing controlling means and the second display changing controlling means;
the specification accepting means successively changes a character to be selected one by one in a predetermined displaying sequence for the characters in the list form according to a shifting operation by the user and accepts one character to be selected in a fixing operation by the user as a character specified by the user according to the confirming operation; and
the second display changing controlling means generates an all candidate list composed of all the next candidate characters based on that the total number of the next candidate characters identified by the next candidate character identifying means is equal to or less than the threshold number, continuously arranges next candidate characters belonging to an identical character group in a lump in the all candidate list, causes the image display device to display the thus arranged all candidate list in the list form, and takes one next candidate character contained in a character group containing the largest number of next candidate characters as a character to be selected.

7. The word input support device of claim 5, wherein:
the control circuit further includes a list display controlling means causing the image display device to display a plurality of characters belonging to a character group to be displayed by the first display changing controlling means and the second display changing controlling means in the list form;
the specification accepting means successively changes a character to be selected one by one in a predetermined displaying sequence for the characters in the list form according to a shifting operation by the user and accepts one character to be selected in a fixing operation by the user as a character specified by the user according to the fixing operation; and
the second display changing controlling means causes the image display device to display an all candidate list composed of all the next candidate characters in the list form based on that the total number of the next candidate characters identified by the next candidate character identifying means is equal to or less than the threshold number, and takes a next candidate character with which the number of registered words beginning with a character string obtained by adding the next candidate character next to the accepted character string of all the next candidate characters is maximized as a character to be selected.

8. The word input support device of claim 7, wherein:
the second display changing controlling means generates an all candidate list composed of all the next candidate characters based on that the total number of the next candidate characters identified by the next candidate character identifying means is equal to or less than the threshold number, arranges all the next candidate characters in the descending order of number of registered words beginning with a character string obtained by adding a relevant next candidate character next to the accepted character string in the all candidate list, and causes the image display device to display the thus arranged all candidate list in the list form.

9. A program device for a computer of a word input support device having a storage medium for storing word dictionary data including a plurality of registered words, the program device causing the computer to function as:
a first display changing controlling means for changing a plurality of character groups each containing a plurality of characters as constituent elements and displaying each character group on the image display device according to an operation by a user;
a specification accepting means for accepting a character, which is specified by the user by utilizing display on the image display device as one character belonging to a current character group being currently displayed on the image display device;
a next candidate character identifying means for identifying, in each of the registered words beginning with the accepted character string, next candidate characters, which come next to the accepted character string obtained by arranging one or more characters accepted by the specification accepting means in the order of acceptance; and
a second display changing controlling means for changing the display on the image display device to any one of character groups, which is other than the current character group and contains one or more next candidate characters of the character groups, if the number of next candidate characters of the current character group identified by the next candidate character identifying means becomes less than a predetermined threshold number.
